(19) United States
(12) Patent Application Publication
(10) Pub. No.: US 2026/0018998 A1
(43) Pub. Date: Jan. 15, 2026

(54) BOOST CIRCUIT STRUCTURE, INVERTER APPARATUS, AND PHOTOVOLTAIC POWER GENERATION SYSTEM

(71) Applicant: SINENG ELECTRIC CO., LTD., Wuxi (CN)

(72) Inventors: Hong YUAN, Wuxi (CN); Jie LUO, Wuxi (CN); Long ZHAO, Wuxi (CN); Qiang ZHU, Wuxi (CN); Zheng CHEN, Wuxi (CN)

(73) Assignee: SINENG ELECTRIC CO., LTD., Wuxi (CN)

(21) Appl. No.: 18/995,176

(22) PCT Filed: Apr. 20, 2023
(86) PCT No.: PCT/CN2023/089473

§ 371 Date: Jan. 16, 2025

(30) Foreign Application Priority Data
Feb. 23, 2023 (CN) 202310157229.5

(51) Int. Cl. H02M 3/158

(52) U.S. Cl. CPC H02M 3/158

(57) ABSTRACT

A boost circuit structure, an inverter apparatus, and a photovoltaic power generation system are provided. The structure includes a switch circuit, a main boost circuit, a branch boost circuit, a first functional circuit, and a second functional circuit. A boost circuit structure frame is formed by the switch circuit, the main boost circuit, and the branch boost circuit, and then the first functional circuit is connected to a flying capacitor and a second input terminal, to charge the flying capacitor in a process of powering on an input side of the boost circuit, thereby protecting a second controllable switch from an overvoltage. In addition, the second functional circuit is connected to a second diode in parallel, to charge the flying capacitor in a process of powering on an output side of the boost circuit, thereby protecting the second diode from an overvoltage.

### CROSS-REFERENCE TO THE RELATED APPLICATIONS

This application is the national phase entry of International Application No. PCT/CN2023/089473, filed on Apr. 20, 2023, which is based upon and claims priority to Chinese Patent Application No. 202310157229.5, filed on Feb. 23, 2023, the entire contents of which are incorporated herein by reference.

### TECHNICAL FIELD

This application pertains to the field of electronic circuit technologies, and in particular, to a boost circuit structure, an inverter apparatus, and a photovoltaic power generation system.

### BACKGROUND

In a flying capacitor boost circuit, when a topology is initially powered on, because the flying capacitor has no voltage, another device is prone to being damaged due to an overvoltage. As shown in FIG. 1, a conventional boost circuit includes an inductor L1, a switch T1, a switch T2, a diode D1, a diode D2, and a flying capacitor C1. When an input side Cin is powered on, if the flying capacitor C1 has no voltage, a voltage of the switch T2 is excessively high. When boost circuits are connected in parallel for use, and when another circuit is first powered on or a subsequent circuit first powers on an output side Cout, because the flying capacitor C1 has no voltage, an overvoltage is prone to being caused to the diode D2. In a photovoltaic application case, in a process in which a switch on a PV (Photovoltaic) side is closed or a bus is powered on, an overvoltage case of a device is particularly severe.

In some existing solutions, a flying capacitor loop is disconnected by an active device, a device voltage is clamped to a corresponding capacitor voltage, and a power-on/off sequence is limited. However, when the active device is used to disconnect a corresponding loop, the loop is closed when a topology normally operates. Consequently, an overall running loss is increased, and more control resources and costs are increased. Clamping of a corresponding device to the corresponding capacitor voltage needs to be implemented by performing corresponding voltage division on a bus by using a capacitor or performing capacitor voltage division on an entire bus. This increases system costs and increases system coupling degree. A power-on/off sequence of a circuit is controlled by using a peripheral circuit or based on an operation sequence. Before a main topology is powered on, a flying capacitor is precharged. This increases control logic and system complexity.

### SUMMARY

This application provides a boost circuit structure, to resolve a problem that system costs, running costs, and control logic and system complexity of an existing flying capacitor boost circuit are high.

According to a first aspect, this application provides a boost circuit structure, including:

a switch circuit, including a first controllable switch and a second controllable switch that are connected in series, where one terminal of the first controllable switch is connected to a first input terminal of a boost circuit by using an inductor, the other terminal of the first controllable switch is connected to one terminal of the second controllable switch, and the other terminal of the second controllable switch is connected to a second input terminal of the boost circuit and a second output terminal of the boost circuit;

a main boost circuit, including a first diode and a second diode, where an anode of the first diode is connected to one terminal of the first controllable switch, a cathode of the first diode is connected to an anode of the second diode, and a cathode of the second diode is connected to a first output terminal of the boost circuit;

a branch boost circuit, including a flying capacitor, where one terminal of the flying capacitor is connected to the other terminal of the first controllable switch, and the other terminal of the flying capacitor is connected to the cathode of the first diode;

a first functional circuit, connected to the flying capacitor and the second input terminal, and configured to charge the flying capacitor when an input side of the boost circuit is powered on; and

a second functional circuit, connected to the second diode in parallel, and configured to charge the flying capacitor when an output side of the boost circuit is powered on.

In some embodiments, the first functional circuit includes a first Zener diode.

A cathode of the first Zener diode is connected to one terminal of the flying capacitor, and an anode of the first Zener diode is connected to the second input terminal.

In some embodiments, the second functional circuit includes a second Zener diode.

An anode of the second Zener diode is connected to the anode of the second diode, and a cathode of the second Zener diode is connected to the cathode of the second diode.

In some embodiments, the first functional circuit further includes a third diode.

The cathode of the first Zener diode is connected to a cathode of the third diode, and is connected to one terminal of the flying capacitor by using the third diode.

In some embodiments, the second functional circuit further includes a fourth diode.

The anode of the second Zener diode is connected to an anode of the fourth diode, and is connected to the anode of the second diode by using the fourth diode.

In some embodiments, the branch boost circuit further includes a first resistor,

and the first functional circuit further includes a second resistor. The first resistor is connected to the flying capacitor in parallel.

The second resistor is connected to the first Zener diode in parallel.

In some embodiments, the second functional circuit further includes a third resistor, and the third resistor is connected to the second diode in parallel.

In some embodiments, the branch boost circuit further includes a fourth resistor and a switch, one terminal of the switch is connected to one terminal of the flying capacitor by using the fourth resistor, and the other terminal of the switch is connected to the second input terminal.

According to a second aspect, this application further provides an inverter apparatus, including the foregoing boost circuit structure.

According to a third aspect, this application further provides a photovoltaic power generation system, including the foregoing inverter apparatus.

Beneficial effects of this application are as follows: In this application, a boost circuit structure frame is formed by the switch circuit, the main boost circuit, and the branch boost circuit, and then the first functional circuit is connected to the flying capacitor and the second input terminal, to charge the flying capacitor in a process of powering on the input side of the boost circuit, thereby protecting the second controllable switch from an overvoltage. In addition, the second functional circuit is connected to the second diode in parallel, to charge the flying capacitor in a process of powering on the output side of the boost circuit, thereby protecting the second diode from an overvoltage.

### BRIEF DESCRIPTION OF THE DRAWINGS

FIG. 1 is a schematic diagram of a circuit structure according to an embodiment of a boost circuit structure in the conventional technology;

FIG. 2 is a schematic diagram of a circuit module according to an embodiment of a boost circuit structure provided in this application;

FIG. 3 is a schematic diagram of a circuit module according to another embodiment of a boost circuit structure provided in this application;

FIG. 4 is a schematic diagram of a circuit structure according to an embodiment of a boost circuit structure provided in this application;

FIG. 5 is a schematic diagram of a circuit structure in which a first functional circuit is further improved according to an embodiment of a boost circuit structure provided in this application;

FIG. 6 is a schematic diagram of a circuit structure in which a second functional circuit is further improved according to an embodiment of a boost circuit structure provided in this application;

FIG. 7 is a schematic diagram of a circuit structure according to another embodiment of the circuit structure shown in FIG. 6;

FIG. 8 is a schematic diagram of a circuit structure according to another embodiment of a boost circuit structure provided in this application;

FIG. 9 is a schematic diagram of a circuit structure according to another embodiment of the circuit structure shown in FIG. 8;

FIG. 10 is a schematic diagram of a current direction according to an embodiment of a boost circuit structure provided in this application;

FIG. 11 is a schematic diagram of a current direction according to another embodiment of the circuit structure shown in FIG. 8;

FIG. 12 is a schematic diagram of a current direction according to another embodiment of a boost circuit structure provided in this application;

FIG. 13 is a schematic diagram of a current direction according to another embodiment of the circuit structure shown in FIG. 12;

FIG. 14 is a schematic diagram of a current direction according to yet another embodiment of a boost circuit structure provided in this application; and

FIG. 15 is a schematic diagram of a current direction according to another embodiment of the circuit structure shown in FIG. 14.

### DETAILED DESCRIPTION OF THE EMBODIMENTS

To make the objectives, technical solutions, and advantages of this application clearer, the following further describes this application in detail with reference to the accompanying drawings and embodiments. It should be understood that the specific embodiments described herein are merely intended to explain this application, and are not intended to limit this application.

In the embodiments of this application, a boost circuit structure frame is formed by a switch circuit, a main boost circuit, and a branch boost circuit, and then the first functional circuit is connected to a flying capacitor and a second input terminal, to charge the flying capacitor in a process of powering on an input side of the boost circuit, thereby protecting a second controllable switch from an overvoltage. In addition, a second functional circuit is connected to a second diode in parallel, to charge the flying capacitor in a process of powering on an output side of the boost circuit, thereby protecting the second diode from an overvoltage.

### Embodiment 1

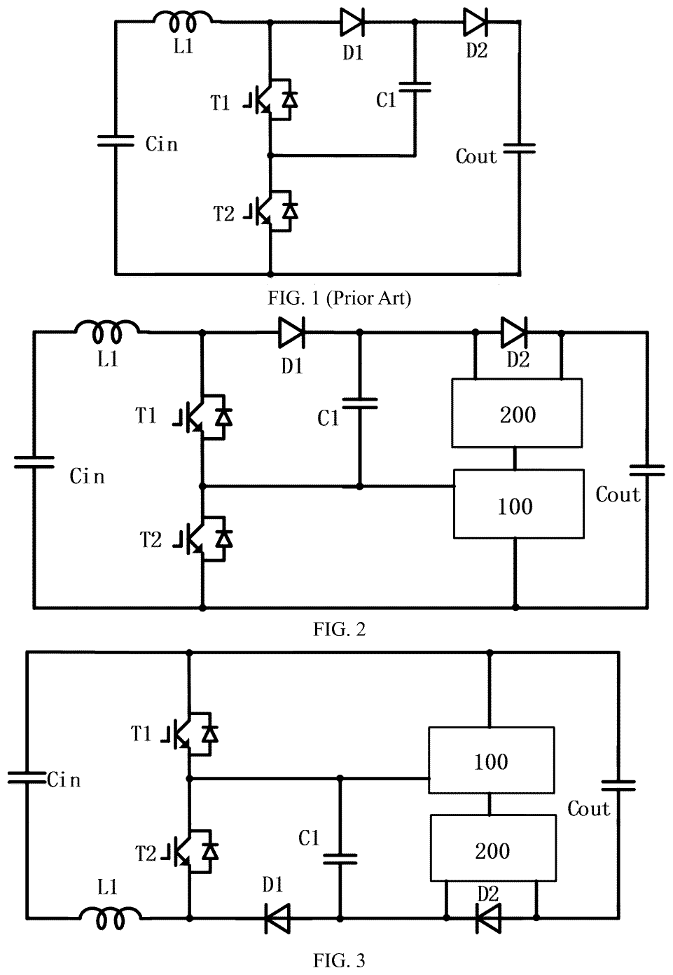

As shown in FIG. 2 to FIG. 15, this embodiment provides a boost circuit structure, including:

a switch circuit, including a first controllable switch T1 and a second controllable switch T2 that are connected in series, where one terminal of the first controllable switch T1 is connected to a first input terminal of a boost circuit by using an inductor L1, the other terminal of the first controllable switch T1 is connected to one terminal of the second controllable switch T2, and the other terminal of the second controllable switch T2 is connected to a second input terminal of the boost circuit and a second output terminal of the boost circuit;

a main boost circuit, including a first diode D1 and a second diode D2, where an anode of the first diode D1 is connected to one terminal of the first controllable switch T1, a cathode of the first diode D1 is connected to an anode of the second diode D2, and a cathode of the second diode D2 is connected to a first output terminal of the boost circuit;

a branch boost circuit, including a flying capacitor C1, where one terminal of the flying capacitor C1 is connected to the other terminal of the first controllable switch T1, and the other terminal of the flying capacitor C1 is connected to the cathode of the first diode D1;

a first functional circuit 100, connected to the flying capacitor C1 and the second input terminal, and configured to charge the flying capacitor C1 when an input side of the boost circuit is powered on; and

a second functional circuit 200, connected to the second diode D2 in parallel, and configured to charge the flying capacitor C1 when an output side of the boost circuit is powered on.

In an implementation, the first controllable switch T1 and the second controllable switch T2 may be power switching transistors. For example, the first controllable switch T1 is a first MOS transistor, and the second controllable switch T2 is a second MOS transistor. A drain of the first MOS transistor is connected to one terminal of the inductor L1, a source of the first MOS transistor is connected to a drain of the second MOS transistor, a source of the second MOS transistor is connected to the second input terminal of the boost circuit and the second output terminal of the boost circuit, and the other terminal of the inductor L1 is connected to the first input terminal of the boost circuit.

In some other embodiments, the first input terminal and the second input terminal of the boost circuit are two terminals on the input side Cin of the boost circuit. For example, the input side Cin of the boost circuit includes a positive input and a negative input, where when the first input terminal is the positive input, the second input terminal is the negative input; and when the first input terminal is the negative input, the second input terminal is the positive terminal.

In some other embodiments, the anode of the first diode D1 is connected to the drain of the first MOS transistor, the cathode of the first diode D1 is connected to the anode of the second diode D2, and the cathode of the second diode D2 is connected to the first output terminal of the boost circuit.

In some other embodiments, the first output terminal and the second output terminal of the boost circuit are two terminals on the output side Cout of the boost circuit. For example, the output side Cout of the boost circuit includes a positive output and a negative output, where when the first output terminal is the positive output, the second output terminal is the negative output; and when the first output terminal is the negative output, the second output terminal is the positive output.

In some other embodiments, one terminal of the flying capacitor C1 is connected to the source of the first MOS transistor, that is, one terminal of the flying capacitor C1 is connected to a line between the first MOS transistor and the second MOS transistor. The other terminal of the flying capacitor C1 is connected to the cathode of the first diode D1, that is, the other terminal of the flying capacitor C1 is connected to a line between the first diode D1 and the second diode D2.

In some other embodiments, the first functional circuit 100 is connected to one terminal of the flying capacitor C1 and the second input terminal. In some possible embodiments, the first functional circuit 100 may be a passive device or an active device that is configured to charge the flying capacitor C1 in a process of powering on the input side Cin, to protect the second controllable switch T2 from an overvoltage.

In some other embodiments, the second functional circuit 200 is connected to the second diode D2 in parallel. In some possible embodiments, the second functional circuit 200 may be a passive device or an active device that is configured to charge the flying capacitor C1 in a process of powering on the output side Cout, to protect the second diode D2 from an overvoltage.

In some embodiments, the boost circuit structure provided in this application may alternatively be adaptively transformed based on an actual requirement and a use environment, for example, transformed to a circuit structure shown in FIG. 3. This is not limited herein.

In this embodiment of this application, a boost circuit structure frame is formed by the switch circuit, the main boost circuit, and the branch boost circuit, and then the first functional circuit 100 is connected to the flying capacitor C1 and the second input terminal, to charge the flying capacitor C1 in the process of powering on the input side of the boost circuit, thereby protecting the second controllable switch T2 from the overvoltage. In addition, the second functional circuit 200 is connected to the second diode D2 in parallel, to charge the flying capacitor C1 in the process of powering on the output side of the boost circuit, thereby protecting the second diode D2 from the overvoltage.

### Embodiment 2

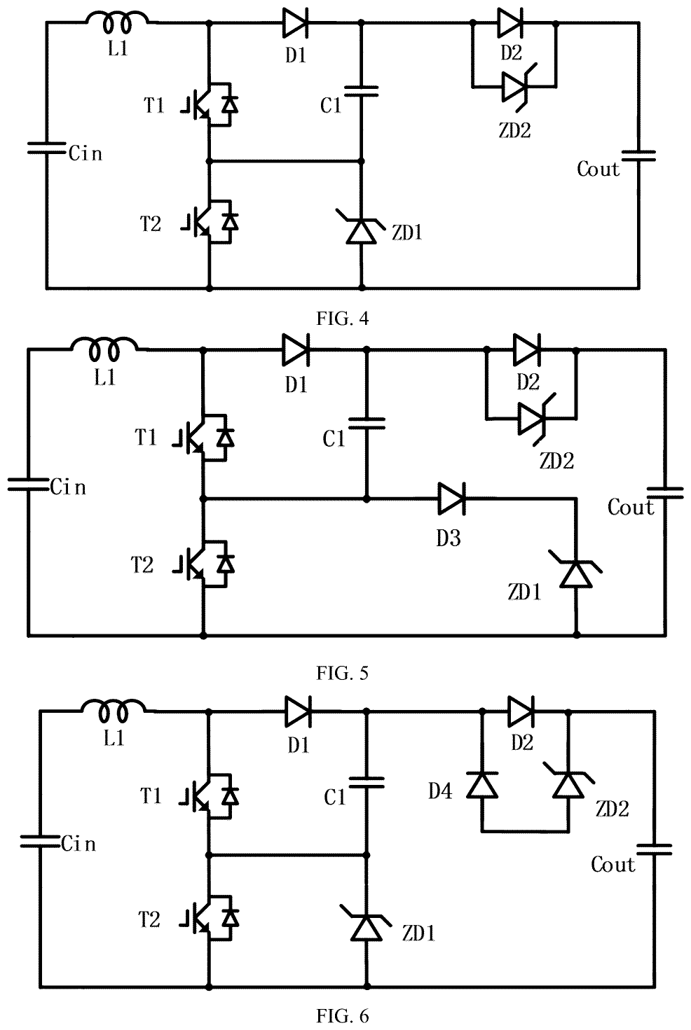

In some optional embodiments, as shown in FIG. 4, the first functional circuit 100 includes a first Zener diode ZD1.

A cathode of the first Zener diode ZD1 is connected to one terminal of the flying capacitor C1, and an anode of the first Zener diode ZD1 is connected to the second input terminal.

In some other embodiments, the second functional circuit 200 includes a second Zener diode ZD2.

An anode of the second Zener diode ZD2 is connected to the anode of the second diode D2, and a cathode of the second Zener diode ZD2 is connected to the cathode of the second diode D2.

In an implementation, when the input side Cin is powered on, a voltage of the flying capacitor C1 is 0. The input side Cin forms a loop by using the inductor L1, the first diode D1, the flying capacitor C1, and the first Zener diode ZD1, to charge the flying capacitor C1. In a breakdown discharge process of the first Zener diode ZD1, a voltage of the second controllable switch T2 may be clamped to a preset voltage, to prevent the second controllable switch T2 from being damaged due to the overvoltage. A power of the first Zener diode ZD1 is associated with a capacitance of the flying capacitor C1.

In some other embodiments, when the output side Cout is powered on, the voltage of the flying capacitor C1 is 0. The output side Cout forms a loop by using the second Zener diode ZD2, the flying capacitor C1, an antiparallel diode of the first controllable switch T1, and the inductor L1, to charge the flying capacitor C1. In a breakdown discharge process of the second Zener diode ZD2, a voltage of the second diode D2 may be clamped to a preset voltage, to prevent the second diode D2 from being damaged due to the overvoltage. A power of the second Zener diode ZD2 is associated with the capacitance of the flying capacitor C1.

### Embodiment 3

In some optional embodiments, as shown in FIG. 5, the first functional circuit 100 further includes a third diode D3.

The cathode of the first Zener diode ZD1 is connected to a cathode of the third diode D3, and is connected to one terminal of the flying capacitor C1 by using the third diode D3.

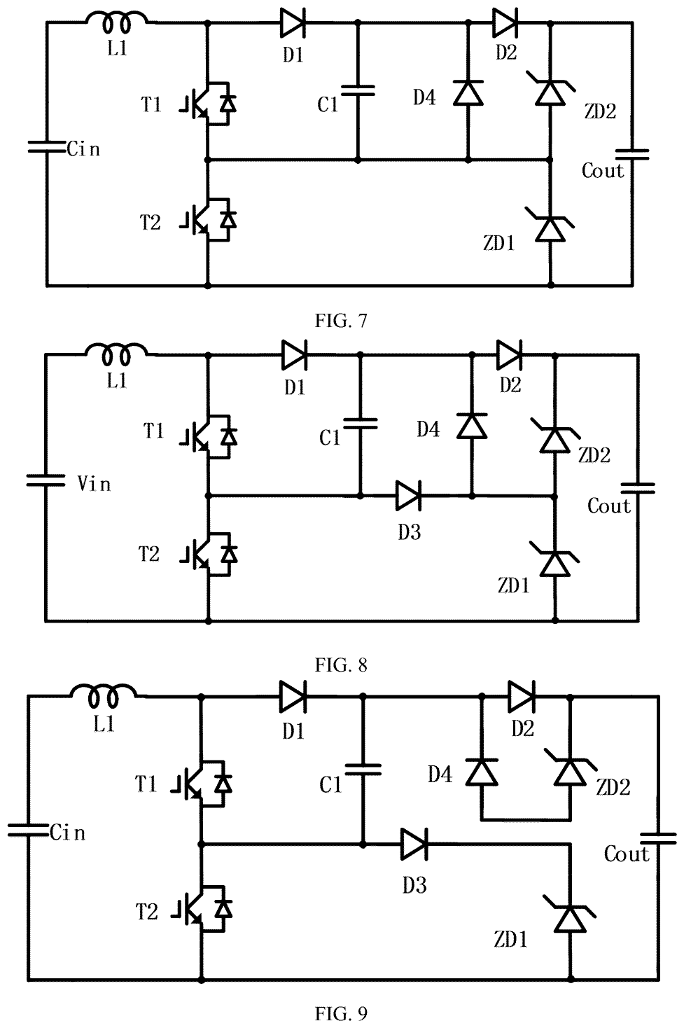

In some other embodiments, as shown in FIG. 6, FIG. 7, FIG. 8, and FIG. 9, the second functional circuit 200 further includes a fourth diode D4.

The anode of the second Zener diode ZD2 is connected to an anode of the fourth diode D4, and is connected to the anode of the second diode D2 by using the fourth diode D4.

In an implementation, the third diode D3 and the fourth diode D4 may be clamping diodes, and the first Zener diode ZD1 and the second Zener diode ZD2 are transient voltage suppression TVS diodes, voltage regulator diodes, or other similar discharge devices. This is not limited herein.

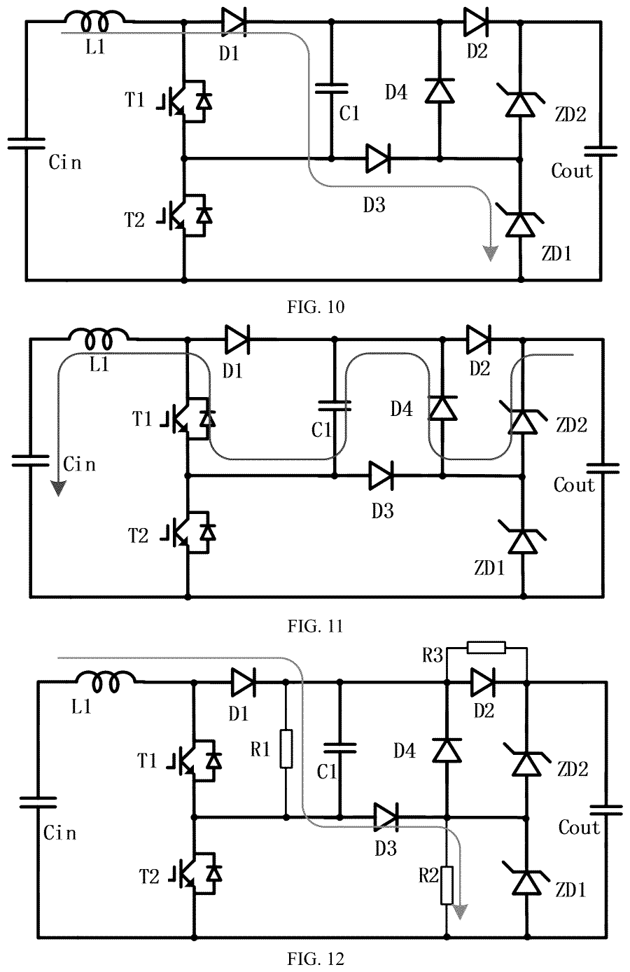

In an implementation, when the input side Cin is powered on, the voltage of the flying capacitor C1 is 0. As shown in FIG. 10, the input side Cin forms a loop by using the inductor L1, the first diode D1, the flying capacitor C1, the third diode D3, and the first Zener diode ZD1, to charge the flying capacitor C1. In the breakdown discharge process of the first Zener diode ZD1, the voltage of the second controllable switch T2 may be clamped to the preset voltage, to prevent the second controllable switch T2 from being damaged due to the overvoltage. The power of the first Zener diode ZD1 is associated with the capacitance of the flying capacitor C1.

In some other embodiments, when the output side Cout is powered on, the voltage of the flying capacitor C1 is 0. As shown in FIG. 11, the output side Cout forms a loop by using the second Zener diode ZD2, the fourth diode D4, the flying capacitor C1, the antiparallel diode of the first controllable switch T1, and the inductor L1, to charge the flying capacitor C1. In the breakdown discharge process of the second Zener diode ZD2, the voltage of the second diode D2 may be clamped to the preset voltage, to prevent the second diode D2 from being damaged due to the overvoltage. The power of the second Zener diode ZD2 is associated with the capacitance of the flying capacitor C1.

Use of passive devices such as a discharge clamp may reduce use of a capacitor, simplifies an operation state of a topology, and reduce system costs.

### Embodiment 4

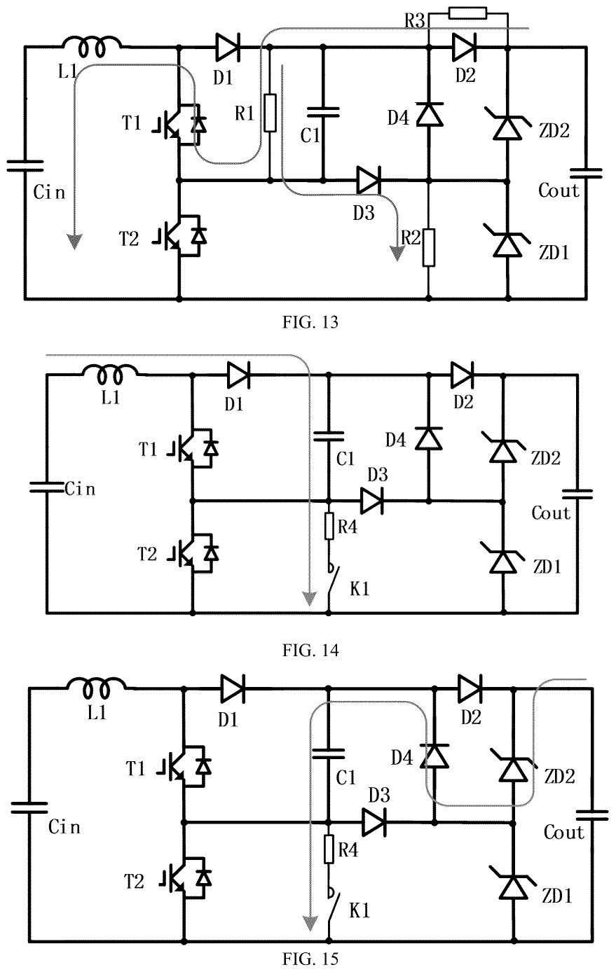

In some optional embodiments, as shown in FIG. 12 and FIG. 13, the branch boost circuit further includes a first resistor R1, and the first functional circuit 100 further includes a second resistor R2.

The first resistor R1 is connected to the flying capacitor C1 in parallel.

The second resistor R2 is connected to the first Zener diode ZD1 in parallel.

In some other embodiments, the second functional circuit 200 further includes a third resistor R3, and the third resistor R3 is connected to the second diode ZD2 in parallel.

In an implementation, secondary precharging may be completed through impedance voltage division in a secondary precharging process of the flying capacitor C1. In the impedance voltage division-based secondary precharging process, system complexity can be reduced. As shown in FIG. 12, in the process of powering on the input side Cin, voltage division is performed on the first resistor R1 and the second resistor R2, a loop is formed by the inductor L1, the first diode D1, the first resistor R1, the third diode D3, and the second resistor R2, to charge the voltage of the flying capacitor C1 to a preset voltage.

In some other embodiments, when a voltage on the input side Cin is low, the voltage of the flying capacitor C1 is low, and a voltage on the output side Cout is high, secondary precharging of the flying capacitor C1 needs to be completed by using energy on the output side Cout. As shown in FIG. 13, one loop is formed by the third resistor R3, the first resistor R1, the antiparallel diode of the first controllable switch T1, the inductor L1, and the input side Cin and one loop is formed by the third resistor R3, the first resistor R1, the third diode D3, and the second resistor R2, to charge the voltage of the flying capacitor C1 to the preset voltage.

### Embodiment 5

In some optional embodiments, as shown in FIG. 14 and FIG. 15, the branch boost circuit further includes a fourth resistor R4 and a switch K1. One terminal of the switch K1 is connected to one terminal of the flying capacitor C1 by using the fourth resistor R4, and the other terminal of the switch K1 is connected to the second input terminal.

In an implementation, because impedance voltage division-based secondary precharging starts slowly, in the secondary precharging process of the flying capacitor C1, secondary precharging may be completed by using an active device, namely, the switch K1. As shown in FIG. 14, in the process of powering on the input side Cin, the voltage of the flying capacitor C1 is charged to the preset voltage by using a loop formed by the inductor L1, the first diode D1, the flying capacitor C1, the fourth resistor R4, and the switch K1. When the voltage on the output side Cout is high, as shown in FIG. 15, the voltage of the flying capacitor C1 may be charged to the preset voltage by using a loop formed by the second Zener diode ZD2, the fourth diode D4, the flying capacitor C1, the fourth resistor R4, and the switch K1. After the voltage of the flying capacitor C1 reaches the preset voltage, the switch K1 is disconnected from the main circuit.

It should be noted that the functional unit devices in the foregoing circuit do not participate in operation in a normal operation process of the topology, and perform an action only in a power-on process or in an abnormal operation process of the circuit. Therefore, an operation status of the circuit and system heat are not affected.

### Embodiment 6

In some embodiments, this application further provides an inverter apparatus, including the foregoing boost circuit structure.

In an implementation, the inverter apparatus is an apparatus for converting a direct current into an alternating current, and may be used for various alternating current power supplies. In some other embodiments, the inverter apparatus includes a switch circuit, a main boost circuit, a branch boost circuit, a first functional circuit 100, and a second functional circuit 200, where the switch circuit includes a first controllable switch T1 and a second controllable switch T2 that are connected in series, one terminal of the first controllable switch T1 is connected to a first input terminal of a boost circuit by using an inductor L1, the other terminal of the first controllable switch T1 is connected to one terminal of the second controllable switch T2, and the other terminal of the second controllable switch T2 is connected to a second input terminal of the boost circuit and a second output terminal of the boost circuit. The main boost circuit includes a first diode D1 and a second diode D2. An anode of the first diode D1 is connected to one terminal of the first controllable switch T1, a cathode of the first diode D1 is connected to an anode of the second diode D2, and a cathode of the second diode D2 is connected to a first output terminal of the boost circuit. The branch boost circuit includes a flying capacitor C1, one terminal of the flying capacitor C1 is connected to the other terminal of the first controllable switch T1, and the other terminal of the flying capacitor C1 is connected to the cathode of the first diode D1. The first functional circuit 100 is connected to the flying capacitor C1 and the second input terminal, and is configured to charge the flying capacitor C1 when an input side of the boost circuit is powered on. The second functional circuit 200 is connected to the second diode D2 in parallel, and is configured to charge the flying capacitor C1 when an output side of the boost circuit is powered on.

In an implementation, the first controllable switch and the second controllable switch may be power switching transistors. For example, the first controllable switch T1 is a first MOS transistor, and the second controllable switch T2 is a second MOS transistor. A drain of the first MOS transistor is connected to one terminal of the inductor L1, a source of the first MOS transistor is connected to a drain of the second MOS transistor, a source of the second MOS transistor is connected to the second input terminal of the boost circuit and the second output terminal of the boost circuit, and the other terminal of the inductor L1 is connected to the first input terminal of the boost circuit.

In some other embodiments, the first input terminal and the second input terminal of the boost circuit are two terminals on the input side Cin of the boost circuit. For example, the input side Cin of the boost circuit includes a positive input and a negative input, where when the first input terminal is the positive input, the second input terminal is the negative input; and when the first input terminal is the negative input, the second input terminal is the positive terminal.

In some other embodiments, the anode of the first diode D1 is connected to the drain of the first MOS transistor, the cathode of the first diode D1 is connected to the anode of the second diode D2, and the cathode of the second diode D2 is connected to the first output terminal of the boost circuit.

In some other embodiments, the first output terminal and the second output terminal of the boost circuit are two terminals on the output side Cout of the boost circuit. For example, the output side Cout of the boost circuit includes a positive output and a negative output, where when the first output terminal is the positive output, the second output terminal is the negative output; and when the first output terminal is the negative output, the second output terminal is the positive output.

In some other embodiments, one terminal of the flying capacitor C1 is connected to the source of the first MOS transistor, that is, one terminal of the flying capacitor C1 is connected to a line between the first MOS transistor and the second MOS transistor. The other terminal of the flying capacitor C1 is connected to the cathode of the first diode D1, that is, the other terminal of the flying capacitor C1 is connected to a line between the first diode D1 and the second diode D2.

In some other embodiments, the first functional circuit 100 is connected to one terminal of the flying capacitor C1 and the second input terminal. In some possible embodiments, the first functional circuit 100 may be a passive device or an active device that is configured to charge the flying capacitor C1 in a process of powering on the input side Cin, to protect the second controllable switch T2 from an overvoltage.

In some other embodiments, the second functional circuit 200 is connected to the second diode D2 in parallel. In some possible embodiments, the second functional circuit 200 may be a passive device or an active device that is configured to charge the flying capacitor C1 in a process of powering on the output side Cout, to protect the second diode D2 from an overvoltage.

In this embodiment of this application, a boost circuit structure frame is formed by the switch circuit, the main boost circuit, and the branch boost circuit, and then the first functional circuit 100 is connected to the flying capacitor C1 and the second input terminal, to charge the flying capacitor C1 in the process of powering on the input side of the boost circuit, thereby protecting the second controllable switch T2 from the overvoltage. In addition, the second functional circuit 200 is connected to the second diode D2 in parallel, to charge the flying capacitor C1 in the process of powering on the output side of the boost circuit, thereby protecting the second diode D2 from the overvoltage.

It can be clearly understood by a person skilled in the art that, for ease of brief description, for a structure and an implementation principle of the foregoing inverter apparatus, refer to corresponding structure and implementation principle in the foregoing Embodiments 1 to 5. Details are not described herein again.

### Embodiment 7

In some embodiments, this application further provides a photovoltaic power generation system, including the foregoing inverter apparatus.

It can be clearly understood by a person skilled in the art that, for ease of brief description, for a structure and an implementation principle of the foregoing photovoltaic power generation system, refer to corresponding structure and implementation principle in the foregoing Embodiments 1 to 6. Details are not described herein again.

The foregoing descriptions are merely preferred embodiments of this application, but are not intended to limit this application. Any modification, equivalent replacement, or improvement made without departing from the spirit and principle of this application should fall within the protection scope of this application.

What is claimed is:

1. A boost circuit structure, comprising:
a switch circuit, comprising a first controllable switch and a second controllable switch that are connected in series, wherein a first terminal of the first controllable switch is connected to a first input terminal of a boost circuit by using an inductor, a second terminal of the first controllable switch is connected to a first terminal of the second controllable switch, and a second terminal of the second controllable switch is connected to a second input terminal of the boost circuit and a second output terminal of the boost circuit;
a main boost circuit, comprising a first diode and a second diode, wherein an anode of the first diode is connected to the first terminal of the first controllable switch, a cathode of the first diode is connected to an anode of the second diode, and a cathode of the second diode is connected to a first output terminal of the boost circuit;
a branch boost circuit, comprising a flying capacitor, wherein a first terminal of the flying capacitor is connected to the second terminal of the first controllable switch, and a second terminal of the flying capacitor is connected to the cathode of the first diode;
a first functional circuit, connected to the flying capacitor and the second input terminal, and configured to charge the flying capacitor when an input side of the boost circuit is powered on; and
a second functional circuit, connected to the first functional circuit and connected to the second diode in parallel, and configured to charge the flying capacitor when an output side of the boost circuit is powered on, wherein
the first functional circuit comprises a first Zener diode and a third diode;
a cathode of the first Zener diode is connected to a cathode of the third diode, and is connected to the first terminal of the flying capacitor by using the third diode, and an anode of the first Zener diode is connected to the second input terminal;
the second functional circuit comprises a second Zener diode; and
an anode of the second Zener diode is connected to the anode of the second diode and the cathode of the first Zener diode, and a cathode of the second Zener diode is connected to the cathode of the second diode.

2. (canceled)

3. (canceled)

4. (canceled)

5. The boost circuit structure according to claim 1, wherein the second functional circuit further comprises a fourth diode; and
the anode of the second Zener diode is connected to an anode of the fourth diode, and is connected to the anode of the second diode by using the fourth diode.

6. The boost circuit structure according to claim 5, wherein the branch boost circuit further comprises a first resistor, and the first functional circuit further comprises a second resistor;
the first resistor is connected to the flying capacitor in parallel; and
the second resistor is connected to the first Zener diode in parallel.

7. The boost circuit structure according to claim 6, wherein the second functional circuit further comprises a third resistor, and the third resistor is connected to the second diode in parallel.

8. The boost circuit structure according to claim 5, wherein the branch boost circuit further comprises a fourth resistor and a switch, a first terminal of the switch is connected to the first terminal of the flying capacitor by using the fourth resistor, and a second terminal of the switch is connected to the second input terminal.

9. An inverter apparatus, comprising the boost circuit structure according to claim 1.

10. A photovoltaic power generation system, comprising the inverter apparatus according to claim 9.
